(19) United States
(12) Patent Application Publication
(10) Pub. No.: US 2008/0220135 A1
(43) Pub. Date: Sep. 11, 2008

(54) Dual Chamber Salad Container

(76) Inventors: David Watzke, Placentia, CA (US); Maureen Watzke, Placentia, CA (US)

Correspondence Address: LOEB & LOEB, LLP, 321 NORTH CLARK, SUITE 2300, CHICAGO, IL, 60610-4746, US

(21) Appl. No.: 12/126,676

(22) Filed: May 23, 2008

Related U.S. Application Data
(62) Division of application No. 10/412,008, filed on Apr. 11, 2003, now abandoned.

(51) Int. Cl. A23L 1/00

(52) U.S. Cl. 426/405

(57) ABSTRACT

The present invention comprises a salad container having a container body an open top, an exterior surface and an interior surface defining a cavity, the cavity divided into an upper chamber and a lower chamber by a selective barrier secured to the interior surface of the body to selectively exclude relatively large ingredients such as salad roughage from entry into the lower chamber and to provide passage therethrough of relatively small food ingredients, such as granular ingredients including, for example, ground pepper and/or such as liquids, including, for example, salad dressing, into and out of the lower chamber.

### BACKGROUND OF THE INVENTION

In the food service industry, it has long been desirable to delay mixing certain food ingredients together until just prior to consumption. The service of fresh green salad is one such example. Dressing added to the salad just prior to its consumption advantageously preserves the freshness, crispness, and distinctive taste of the greens, croutons, and other rough ingredients that are susceptible to dressing absorption. All too frequently, dressing is applied to roughage too early resulting m a drenched, wilted, and limp concoction than is rejected by consumers as inferior. When ordering a Caesar salad, for instance, it is traditional for the salad dressing to be prepared tableside and then rapidly tossed with the other ingredients such as romaine lettuce and croutons for immediate transfer onto a diner's plate for enjoyment. Tableside preparation, however, is costly and time consuming and not particularly well salted to the fast-food or high volume food service industries.

Consumers, restaurateurs, the fast-food industry, and institutional food preparation services continue to demand food products that are high quality, convenient, quick to prepare, and economical to produce. Fast-food outlets, for example, frequently offer salads in the form of rough ingredients such as greens, croutons, radishes, cucumbers, carrots, meat and/or cheese combined together in a disposable individual container. The salad dressing, however, is frequently offered in a separate packet that requires cumbersome handling and opening before the contents therein are squeezed out onto the roughage. Typically, the roughage container also includes a lid that must be removed before the packet contents are added thereover. Once the dressing is squeezed onto the roughage, implements such as a fork, spoon or knife individually or in combination, are then used to distribute the dressing throughout the roughage. The action required of the implements to evenly distribute the dressing often results in substantial amounts of ingredients and dressing disadvantageously overflowing and tumbling out of the container onto the table, the clothes of the consumer, and, not infrequently, onto the floor.

Schools and other high volume institutions provide similar individual holding containers for salad roughage. The salad dressing, however, is frequently offered in a separate portion cup to be added atop the salad greens. Similarly, to thoroughly distribute the dressing among the roughage requires use of implements resulting in spillage and mess. Moreover, both dressing packets and cups are costly and inconvenient and require significant dexterous manipulation to use.

Large commercial eateries often separately store salad roughage in large plastic bins and dressing in other containers until it is desirable for both to be combined and mixed together just prior to serving. Once the desired dressing and roughage containers are located and opened, the dressing is poured onto the roughage. Alternatively, and depending on the size of the dressing container, the roughage may be introduced to the dressing. In either case, use of implements to toss the salad and distribute the dressing soon follows with its attendant and disadvantageous spillage, waste and mess. From the salad remaining in the mixing container, individual portions are then distributed onto individual plates and served.

There thus exists a long felt need for an improved salad container that eliminates the need to store, in separate containers, large ingredients such as salad roughage apart from smaller or liquid ingredients, such as salad dressing, until mixing them together is desired. It has been further long desired that a container be provided to eliminate the need to use mixing or tossing implements and the undesirable spillage, waste and mess resulting from use thereof.

### SUMMARY OF THE INVENTION

Generally, the present invention comprises a salad container having a container body with an open top, an exterior surface and an interior surface defining a cavity, the cavity divided into an upper chamber and a lower chamber by a selective barrier secured to the interior surface of the body to selectively exclude relatively large ingredients such as salad roughage from entry into the lower chamber and to provide passage therethrough of relatively small food ingredients, such as granular ingredients including, for example, ground pepper and/or liquids such as salad dressing, into and out of the lower chamber. In at least one embodiment of the present invention, the barrier is integrally secured to the body. In another embodiment, the barrier is releasably secured to the body. Each of the embodiments may include a detachable lid which may be used, for example, to close the container body when desired for storage of contents therein and/or for inverting the container passing the contents of the lower chamber into the upper chamber and shakingly mixing together the contents of both chambers without need of implements.

These and other features and advantages of the present invention will become apparent from the following detailed description which taken in conjunction with the accompanying drawings, further describes and illustrates by way of example the principles of the invention.

### BRIEF DESCRIPTION OF THE DRAWINGS

FIG. 1 is a perspective view of an embodiment of the present invention wherein the barrier is formed as an integral part of the container body;

FIG. 2 is a top view of an embodiment of the present invention wherein the barrier is formed as part of the container body;

FIG. 3 is cross sectional view along the lines depicted in FIG. 2 with added salad roughage in the upper chamber and added dressing in the lower chamber;

FIG. 4 is a perspective view of as embodiment of the present invention wherein the barrier is secured to the interior wall of the container body;

FIG. 5 is an offset cross sectional view along the lines depicted in FIG. 4 through two of the three barrier retainers with added salad roughage in the upper chamber and added dressing in shortened lower chamber;

FIG. 6 is as inverted view of the cross sectional view of FIG. 5 showing the dressing gravitationally flowing into the upper chamber;

FIG. 7 is a perspective view of an embodiment of the present invention wherein the barrier is secured beneath a deformable rim in the interior surface of the container body; and

FIG. 8 is a cross sectional view along the lines depicted in FIG. 7 with added dressing in the lower chamber.

### DETAILED DESCRIPTION OF PREFERRED EMBODIMENTS

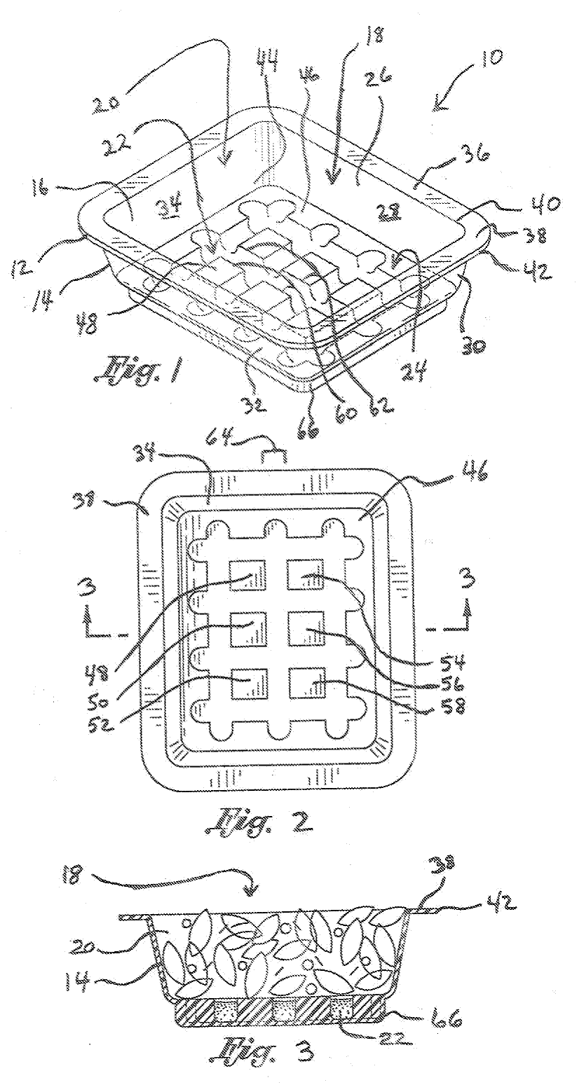

Referring first to FIGS. 1 and 2, generally designated by the numeral 10 is a preferred embodiment of the salad container of the present invention. The container of this embodiment is sized for an individual salad comprising a rectangular-shaped unitary container body 12 having an imaginary central vertical axis, an open top, an exterior surface 14 and an interior surface 16 defining a cavity 18, the cavity divided into an upper chamber 20 and a lower chamber 22 by a selective barrier 24 having an opening comprising a grid of interconnected trough depressions defining the lower chamber.

The upper chamber 20 is laterally defined by a nearly vertical radially contiguous body wall having an interior wall surface 26 comprising four interconnected panel surfaces 28, 30, 32, and 34, the interior wall surface terminating in height in a contiguous rim 36 having a horizontal rim surface 38 and an inner and outer rim edge 40 and 42 respectively, the interior wall surface tapering inwardly on descent and terminating in a radially contiguous interior wall bottom surface 44. Integrally secured to the interior wall bottom surface is a plurality of upwardly facing barrier surfaces including a perimeter barrier surface 46 and six interior barrier surfaces 48, 50, 52, 54, 56, and 58 integrally connected to the trough depressions therebetween, the crossing trough depressions isolating the barrier surfaces from one another, the grid opening cooperating with the barrier surfaces to form the selective barrier 24.

The troughs are arranged in parallel and perpendicularly crossing configuration, each trough having opposing longitudinally parallel interior surface top edges 60 and 62 connected to adjacent barrier surfaces and positioned sufficiently apart by a distance 64 to selectively exclude relatively large ingredients, such as salad roughage, from entry into the lower chamber and to provide passage therethrough of relatively small food ingredients, such as granular ingredients, including, for example, ground pepper and/or such as liquids, including, for example, salad dressing, into and out of the lower chamber. In the present embodiment, the distance across opposing parallel interior surface trough edges is about one fourth of an inch. This distance may be varied depending on the size of ingredients desired to be thwarted from entry into the lower chamber.

Extending from the exterior surface 14 of the underside of the body 12 is an optional stand 66 to support the container at rest on a level surface. In alternative embodiments, the stand may be omitted, the body thus resting directly on the exterior surface 14 of the trough bottoms (not shown). The omission of a stand may also provide for close nesting together of multiple containers. The container of the present invention may be reused or may be discarded, the opening formed by the grid of troughs providing easy access to the lower chamber for cleaning.

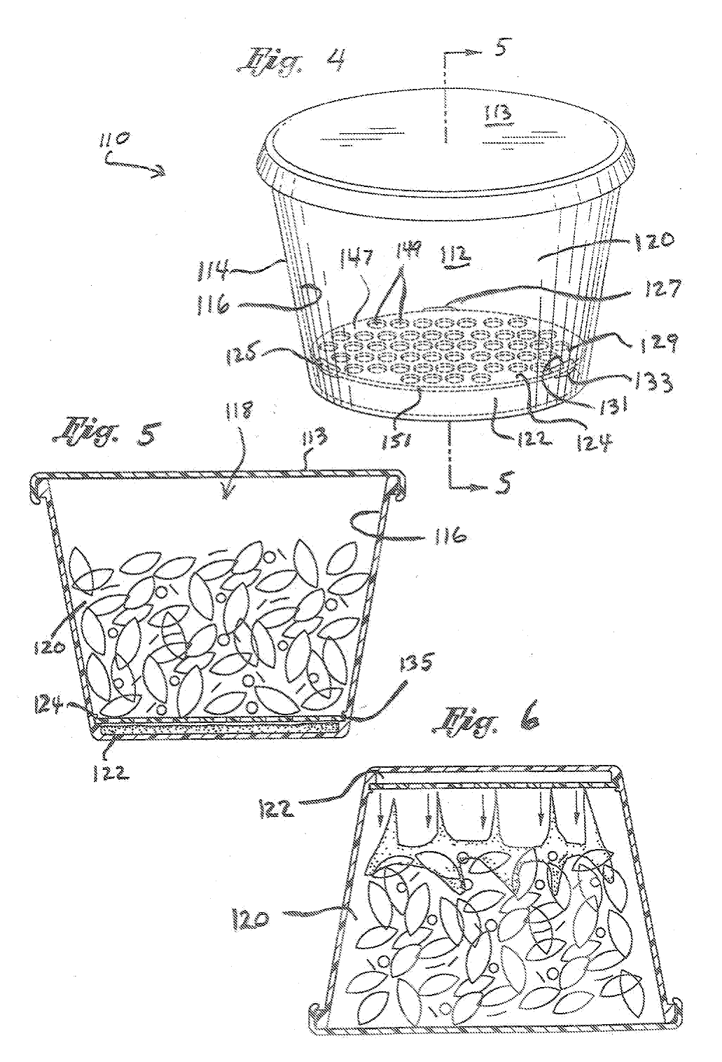

Referring to FIG. 3, a cross-section of the present preferred embodiment is shown representing salad roughage being supported in the upper chamber 20 and dressing residing in at least three troughs of the lower chamber 22 in a storage configuration, the selective barrier surfaces blocking entry of roughage into the lower chamber and desirably preventing the roughage from lying in the dressing and becoming soaked and wilted thereby. The relatively small ingredients or dressing may be preloaded into the lower chamber 22 before the roughage is added, may be injected into the lower chamber beneath the roughage, may be added on lop of the roughage, or may gravitationally flow from the lower chamber into the upper chamber once the container body is inverted as desired. The lower chamber also may provide a reservoir for the collection of liquid such as water from freshly washed roughage or excess dressing as desired.

Alternative embodiments of the container body may utilize, for example, one or more upwardly facing barrier surfaces and at least one opening cooperatively forming the selective barrier. For example, in one alternative embodiment (not shown), the upwardly facing barrier surface may be limited to a central island surrounded by an annular trough defining the lower chamber, the opening to the lower chamber and the upwardly facing barrier surface cooperatively forming the selective barrier. More specifically, the embodiment includes a cylindrically shaped body with an open top having a downwardly extending body wall turned inwardly at its bottom to form a stand and upwardly terminating in a radially contiguous inner wall, the inner surface of the inner wall apart from and facing in opposition the interior surface of the body wail defining an annular lower chamber, the inner surface of the inner wall having a radially contiguous inner wall top edge, the inner wall top edge being integrally secured to the perimeter of a single centrally positioned upwardly facing barrier surface, a single surrounding opening formed between the inner wall top edge and the interior surface of the body wall and cooperating with the barrier surface to provide a selective barrier to exclude relatively large ingredients from entry into the lower chamber and provide passage therethrough of relatively small food ingredients into and out of the lower chamber. In another embodiment (not shown), the selective barrier includes an opening comprising a depression configured in the form of a spirally configured channel defining the lower chamber, the spiral channel having a pair of channel walls with channel top edges, the channel top edges being connected adjacently to a spirally configured upwardly facing barrier surface.

The container of the present invention 10 may also include a lid (not shown) to cover the cavity 18 for covered storage of roughage and dressing therein and/or for shakingly mixing the contents therein together without use of implements. Distribution of dressing throughout the roughage may be provided without use of implements and the attendant spillage and mess caused by usage thereby, by flipping over and shaking the covered container and its contents, the dressing from the lower chamber 22 flowing into the upper chamber 20 and being shakenly distributed throughout the roughage as desired. The lid may he configured, for example, as a domed or flat snapably securable resilient cover or may be foil or plastic film sheeting or other varieties as are known in the art.

Referring to FIGS. 4 and 5, is shown an alternative embodiment of the present invention. Shown is a container 110 having a cylindrical downwardly tapering container body 112 having an exterior surface 114 and an interior surface 116 defining a cavity 118 and including a securable lid 113, the cavity divided into an upper chamber 120 and a lower chamber 122 by a selective barrier 124 releasably secured to the interior surface of the body by three barrier retainers 125, 127, and 129 formed on the interior surface of the body, each retainer having an upper portion 131 and a lower portion 133. The selective barrier includes an upwardly facing barrier surface 147, and a plurality of openings 149 therethrough of sufficient dimension to selectively exclude relatively large ingredients such as salad roughage from entry into the lower chamber and to provide passage therethrough of relatively small food ingredients, such as granular ingredients including, for example, ground pepper and/or such as liquids, including, for example, salad dressing, into and out of the lower chamber.

In the present embodiment, each opening is bounded by a vertically tubular inner wall having a diameter of about one fourth of an inch. This distance may be varied depending on the size of ingredients desired to be thwarted from entry into the lower chamber 122. The barrier may alternatively be configured to include inner walls defining the barrier openings in a variety of configurations including slotted forms, upwardly or downwardly projecting nozzles, and/or other shapes known in the art.

The barrier retainers 125, 127, and 129 may be in the form of small ribs, nodes, bosses, or protrusions each having a notch 135 between the upper and lower portions 131, 133, the barrier 124 and the body 112 being sized and configured with sufficient cooperative flexibility for the barrier to be press fit into the notches securing the barrier in position dividing the cavity into the upper chamber 120 and lower chamber 122. The barrier and body are also cooperatively configured to provide for the removal of the barrier by grasping the barrier through at least one of its openings with fingertips or a small hooked implement (not shown). A gripping post (not shown) or other removal enhancing feature may be formed on the upwardly facing barrier surface 147 as desired. Removal of the barrier provides for ease of cleaning, ease of reuse, and for a container body that may be converted, as desired, to use without the barrier dividing the cavity into upper and lower chambers.

The upper portion 131 of each barrier retainer functions to retain the barrier 124 in operable position preventing it from prematurely dislodging when the container body 112 is inverted. Alternatively, the container body may be provided without the lower portion 133 of each retainer should the barrier be sized with a barrier edge 151 to sufficiently interfere with the downwardly tapering interior surface 116 of the body at a location just beneath the upper portions of the retainers and above the bottom of the lower chamber 122. Optionally, the interior wall of the body may be formed with a retaining annular slot for securing the barrier. Alternatively, the barrier may be permanently secured to the interior surface of the body at securing points on the interior surface of the body wall or may be releasably or permanently secured circumferentially at the barrier edge to the interior surface by methods and apparatus known in the art. Although optional, it is not required that the barrier edge be sealingly secured to the interior surface of the body. Alternatively, at least one opening may be located only through the barrier edge. Optionally, the barrier may include only a single opening for passage of dressing or small ingredients into and out of the lower chamber. Additionally optionally, the salad container may configured in the form of a kit comprising the container body and the releasably securable selective barrier.

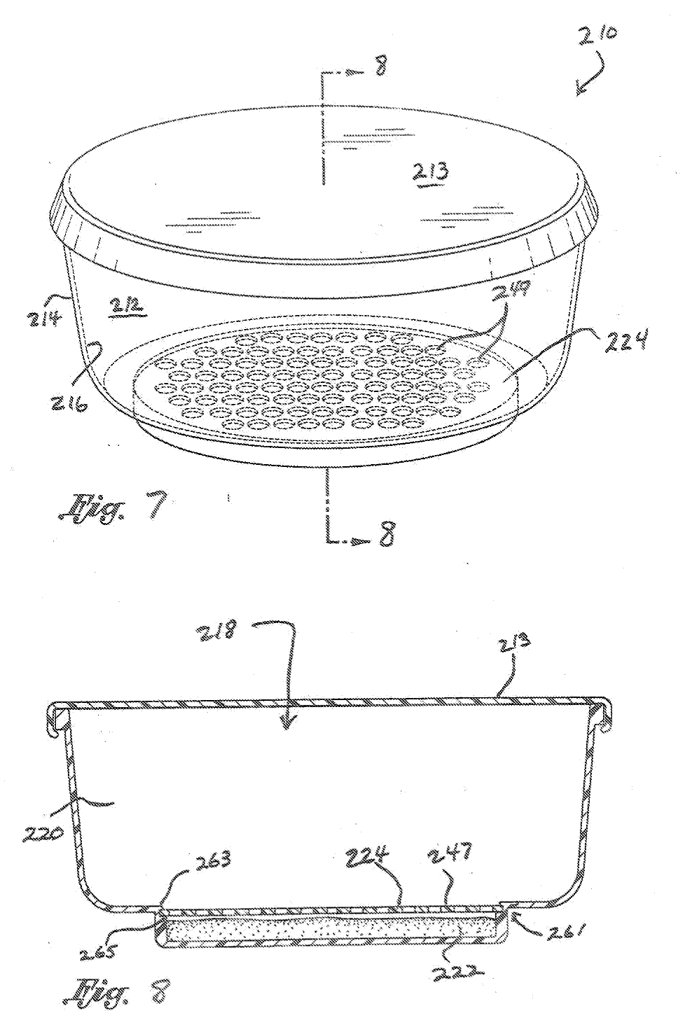

Referring to FIG. 6, the container 110 is shown inverted, the dressing in the lower chamber 122 shown gravitationally dripping through the openings in the selective barrier 124 and over the roughage contained in the upper chamber 120. Alternatively, the optional lid may not be deployed, the container body 112 being invertible directly onto a plate with roughage and dressing in the upper and lower chambers respectively, the dressing gravitationally flowing onto the roughage from the lower chamber of the inverted body, the body being removable away from the contents when desired.

Referring to FIGS. 7 and 8, a larger commercial sized container 210 is shown having a container body 212 with an open top, an exterior surface 214, and an interior surface 216 defining a cavity 218, and including a securable lid 213 to cover the open top, the cavity divided into an upper chamber 220 and a lower chamber 222 by a selective barrier 224 releasably secured to the interior surface of the body by an annular barrier retainer 261 formed on the interior surface of the body, the retainer having an annular upper rim 263 and an annular seat 265 formed to secureably receive the barrier. The selective barrier includes an upwardly facing barrier surface 247, and a plurality of openings 249 therethrough of sufficient dimension to selectively exclude relatively large ingredients such as salad roughage from entry into the lower chamber and to provide passage therethrough of relatively small food ingredients, such as granular ingredients including, for example, ground pepper and/or such as liquids, including, for example, salad dressing, into and out of the lower chamber.

The container of the present invention may be formed, for example, from polystyrene, polyethylene, polypropylene, or other plastics by methods known to those of skill in the art. Other materials, such as, for example, rigidized paper or pulp materials may be employed as would be known in the art. Metal, such as, for example, stainless steel or aluminum may also be employed as desired. The components of the present invention may also be made from differing materials. By way of example, the container body may be made of stainless steel and the barrier may be made of plastic material.

Configurations of alternative embodiments of the present invention may vary considerably. The shape of the container body, for example, may be round, oval, square, or other shapes as desired and known by those skilled in the art. The upper and lower chambers too may be of varying sizes and shapes as desired.

The salad container of the present invention may also vary in size for use in individual and/or commercial and institutional configurations. Moreover, the salad container of the present invention is not limited to containing and storing salad ingredients, but may also be used to contain and store other foodstuffs separately in the same container until ready for consumption. For example, cooked pasta may be stored in the upper chamber of the present invention and pasta sauce separately in the lower chamber. These foods may be mixed together when desired from the same container as described for salad materials desirably preserving the distinctive flavors of the foods in the separate chambers of the container until ready to be consumed.

Having described only typical forms and applications of the present invention, it is not intended that the invention be limited to the specific details herein set forth. While a particular form of the invention has been illustrated and described, it will also be apparent to those skilled in the art that various modifications can be made without departing from the spirit and scope of the invention. Accordingly, it is not intended that the invention be limited except by the appended claims.

1-29. (canceled)

30. A comprising:
selecting a container body having an open top, an exterior surface and an interior surface defining a cavity and a lid;
dividing the cavity into an upper chamber and a lower chamber by a selective barrier;
sufficiently configuring the barrier to selectively exclude entry of relatively large food items into the lower chamber and to provide passage through the barrier of relatively small food ingredients into and out of the lower chamber;
sealing the open top of the container body after placing relatively large food items in the upper chamber, relatively small food ingredients in the lower chamber; and
flipping over the sealed container body such that the relatively small food ingredients in the lower chamber flow into the upper chamber.

31. The method of claim 30, wherein the selective barrier is integrally secured to the body.

32. The method of claim 31, wherein the selective barrier is formed as part of the body.

33. The method of claim 30, wherein the selective barrier is releasably secured to the body.

34. (canceled)

35. The method of claim 30, wherein the selective barrier has one opening.

36. The method of claim 30, wherein the selective barrier has one upwardly facing barrier surface.

37. The method of claim 30, wherein the selective barrier has at least one upwardly facing barrier surface.

38. A comprising:
selecting a container body having an open top, an exterior surface and an interior surface defining a cavity;
dividing the cavity into an upper chamber and a lower chamber by a selective barrier having a plurality of openings;
releasably securing the barrier to the interior surface; and
sufficiently configuring the barrier to selectively exclude entry of relatively large food items into the lower chamber and to provide passage of relatively small food ingredients into and out of the lower chamber,
wherein the container comprises a lid.

39. The method of claim 38, wherein the interior surface includes at least one barrier retainer.

40. The method of claim 39, wherein the barrier is sufficiently flexible to be press fit into the at least one retainer.

41. The method of claim 38, wherein the selective barrier has a barrier edge with at least one opening.

42. A method comprising:
selecting materials to form a unitary container body having an open top, an exterior surface and an interior surface defining a cavity, the cavity divided into an upper chamber and a lower chamber by a selective barrier integrally formed as part of the body and having one opening and a plurality of upwardly facing barrier surfaces separated and connected together by a grid of interconnected troughs defining the lower chamber, each trough having opposing longitudinally parallel interior surface top edges connected to adjacent barrier surfaces and positioned sufficiently apart to selectively exclude entry of relatively large food items into the lower chamber and to provide passage of relatively small food ingredients into and out of the lower chamber, and a lid; and
forming said container body.

43. The method of claim 42, wherein the body includes a stand.

44. The method of claim 42, wherein the body includes a rim.

45. (canceled)

46. The method of claim 30, wherein the relatively small food ingredients are added before the cavity is divided into an upper camber and a lower chamber.

47. The method of claim 30, wherein the relatively small food ingredients are added after the cavity is divided into an upper chamber and a lower chamber.

48. The method of claim 30, wherein the relatively small food ingredients are injected after the cavity is divided into an upper chamber and lower chamber.

49. The method of claim 30, further comprising removing the container body, wherein the relatively large food items and the small food ingredients remain on the lid.

50. The method of claim 48, wherein the selective barrier is sufficiently secured to the container body so as to be removed with the container body.

51. The method of claim 30, wherein the relatively small food ingredients are distributed over the relatively large food items after the container body is flipped over.
